(19) United States
(12) Patent Application Publication
(10) Pub. No.: US 2014/0229858 A1
(43) Pub. Date: Aug. 14, 2014

(54) ENABLING GESTURE DRIVEN CONTENT SHARING BETWEEN PROXIMATE COMPUTING DEVICES

(71) Applicants: JULIUS P. BLEKER, KELLER, TX (US); DAVID HERTENSTEIN, COPPELL, TX (US); CHRISTIAN E. LOZA, DENTON, TX (US); MATHEWS THOMAS, FLOWER MOUND, TX (US)

(72) Inventors: JULIUS P. BLEKER, KELLER, TX (US); DAVID HERTENSTEIN, COPPELL, TX (US); CHRISTIAN E. LOZA, DENTON, TX (US); MATHEWS THOMAS, FLOWER MOUND, TX (US)

(73) Assignee: INTERNATIONAL BUSINESS MACHINES CORPORATION, ARMONK, NY (US)

(21) Appl. No.: 13/766,041

(22) Filed: Feb. 13, 2013

(51) Int. Cl. G06F 3/01

(52) U.S. Cl. CPC G06F 3/017
USPC 715/753

(57) ABSTRACT

One or more computing devices proximate to a source device are identified. The source device is an end-user device having a touch sensitive surface. A gesture performed on the touch sensitive surface is detected. The gesture indicates a selection of a displayed representation of content and indicates a direction. The gesture is at least one of a touch based gesture, a stylus based gesture, a keyboard based gesture, and a pointing device gesture. A target device or a device proxy is determined that is within line-of-site of a human being that made the gesture and that is in the direction of the gesture. An action programmatically executes involving the gesture selected content and the determined target device or device proxy.

### BACKGROUND

The present invention relates to the field of content sharing and, more particularly, to enabling gesture driven content sharing between proximate computing devices.

Mobile devices such as mobile phones and portable media players are becoming ubiquitous. Currently, interactions are becoming increasingly complex and sophisticated. static devices and humans are increasing in sophistication However, these methods can lack natural intuitive interactions. That is, user interaction must conform to traditional rigid interaction patterns. For example, to share a file with a proximate friend, currently the file must be shared using several non-intuitive steps (e.g., open your email and attaching the file).

Even though many mobile devices utilize touch based interaction, these interactions still conform to traditional mechanisms. That is, copying and/or sharing content such as movies and music require special applications, addressing information, and specialized interaction knowledge. For example, a user unfamiliar with a file sharing application on a mobile phone must perform trial and error actions (e.g., menu navigation, using a help feature) before learning how to share a file. This approach is cumbersome and time consuming for a user which can negatively impact the user's experience.

### BRIEF SUMMARY

One aspect of the present invention can include a system, an apparatus, a computer program product, and a method for enabling gesture driven content sharing between proximate computing devices. One or more computing devices proximate to a source device can be identified. The source device can be associated with a content. A characteristic of a gesture performed on the source device can be detected. The gesture can be associated with the content within the source device. The gesture can be a touch based gesture, a stylus based gesture, a keyboard based gesture, or a pointing device gesture. A portion of the content, an action, or a one or more target devices can be established in response to the detecting. The target devices can be computing devices. The action associated with the portion of the content on the computing devices can be programmatically run based on the characteristic.

Another aspect of the present invention can include an apparatus, a computer program product, a method, and a system for enabling gesture driven content sharing between proximate computing devices. A collaboration engine can be configured to share content associated with a first computing device and with a second computing device responsive to a gesture performed on the first computing device. A characteristic of the gesture can determine an action performed on the second computing device. The gesture can be a touch based gesture, a stylus based gesture, a keyboard based gesture, or a pointing device gesture. The second computing device can be proximate to the first computing device. A data store can be configured to persist a gesture mapping, an action list, or a spatial arrangement.

Yet another aspect of the present invention can include a computer program product that includes a computer readable storage medium having embedded computer usable program code. The computer usable program code can be configured to identify a source device and one or more target devices. The source device can be proximate to the target devices. The source devices can persist a content. A characteristic of a gesture performed on the source device can be detected. The gesture can be associated with the content within the source device. The gesture can be a touch based gesture, a stylus based gesture, a keyboard based gesture, or a pointing device gesture. A communication link between the source and at the target devices can be established responsive to the detecting. A portion of the content can be selectively shared with the target device via the communication link.

### BRIEF DESCRIPTION OF THE SEVERAL VIEWS OF THE DRAWINGS

FIG. 1 is a schematic diagram illustrating a set of scenarios for enabling gesture driven content sharing between proximate computing devices in accordance with an embodiment of the inventive arrangements disclosed herein.

FIG. 2 is a schematic diagram illustrating a method for enabling gesture driven content sharing between proximate computing devices in accordance with an embodiment of the inventive arrangements disclosed herein.

FIG. 3 is a schematic diagram illustrating a system for enabling gesture driven content sharing between proximate computing devices in accordance with an embodiment of the inventive arrangements disclosed herein.

### DETAILED DESCRIPTION

The present disclosure is a solution for enabling gesture driven content sharing between proximate computing devices. In the solution, communication of content between a source device and one or more target devices can be triggered by a gesture. Gestures can trigger a copy content action, a move content action, and/or mirror content action. For example, flicking content on a device in the physical direction of proximate device can trigger the content to be copied to the proximate device. In one instance, the disclosure can be facilitated by a support server able to register devices, facilitate content transfer/mirroring, and the like. In another embodiment, the disclosure can communicate in a peer-based mode permitting communication of content between proximate devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction handling system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction handling system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

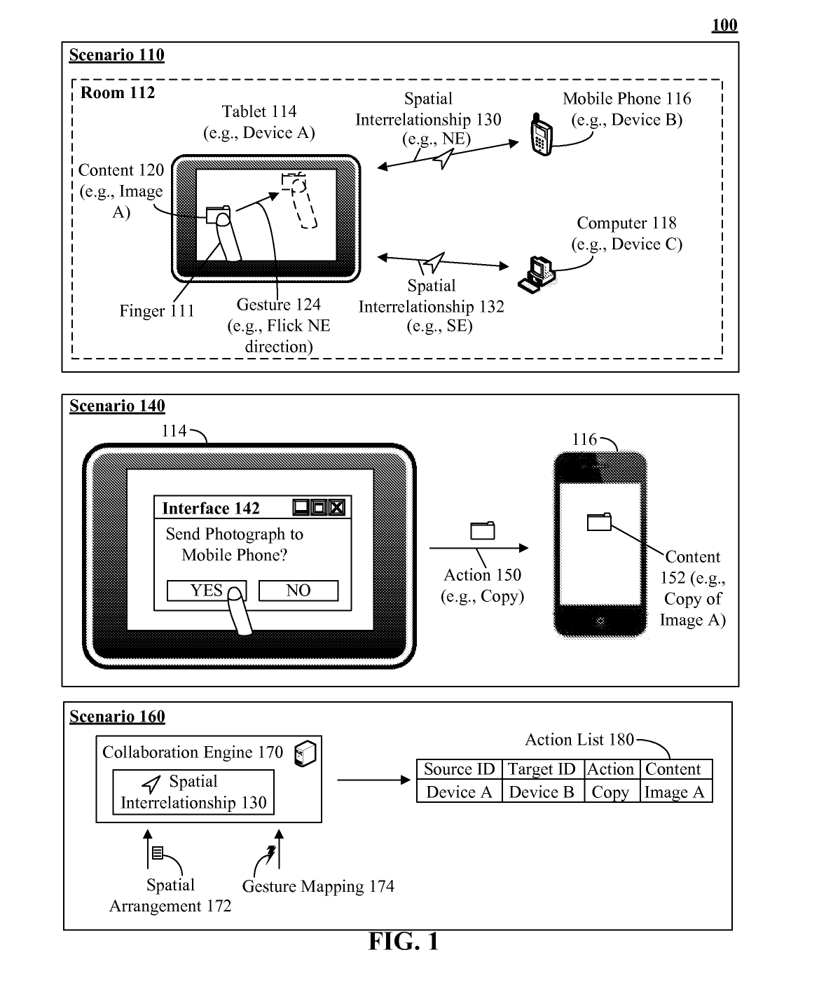

FIG. 1 is a schematic diagram illustrating a set of scenarios 110, 140, 160 for enabling gesture driven content sharing between proximate computing devices in accordance with an embodiment of the inventive arrangements disclosed herein. Scenarios 110, 140, 160 can be performed in the context of method 200 and/or system 300. In scenarios 110, 140, 160, a gesture 124 can trigger content sharing of content 120 between tablet 114 and mobile phone 116. The gesture 124 can be a directional gesture which can correspond to an approximate physical location of a proximate device. For example, a phone 116 north east of tablet 114 can receive an image A (e.g., content 120), when a user performs a flick gesture in the physical direction of device B (e.g., north east) on the image A within tablet 114.

In one embodiment, the gesture 124 can constitute a sliding of a contact object (e.g., finger or stylus) in a directional manner on a touch sensitive screen. During the sliding, the contact object may remain in constant contact with the touch sensitive screen.

In embodiments where directional sliding toward one or more proximate devices or device proxies relative positions of these devices (or device proxies) may be determined. A device proxy represents a person, place, object, etc. that is mapped to a computing device, which is to receive content responsive to a gesture. For example, a person may be a device proxy when gesture maker gestures to that person to deliver content to a device owned by the person. Relative positions of devices (or device proxies) relative to a gesture may be determined using geospatial determinations. These determinations, in one embodiment, are based on a user's line-of-sight and a perspective based on this line-of-sight.

Numerous technique and technologies may be utilized to determine relative positions of devices for purposes of gesture 124 determination. In one embodiment, a rear-facing camera of a tablet 114 can capture images of an environment, which is used to determine spatial interrelationships 130, 132 and proximate device(s) 116 and/or 118. Near field, Infrared, and PAN transceivers may be used in one embodiment to determine spatial interrelationships 130, 132. That is, signals may be conveyed between devices, and computations based on signal strength, RF echoes, triangulation, and the like can be used determine spatial interrelationships 130, 132. In one embodiment, sonic signals (produced via an speaker and received via a speaker) and communicated messages indicating a strength and nature of sonic signals can be utilized to determine spatial interrelationships 130, 132. The scope f this disclosure is not to be limited to any specific technique of spatial interrelationship determination and any technique or combination of techniques known in the art may be utilized and be considered within the intended disclosure scope.

As used herein, content 120, 152 can include, but is not limited to, an audio, a video, a document, and the like. Content 120, 152 can include, but is not limited to, an image media, a video media, a multimedia content, a structured document (e.g., Rich Text Format document), an unstructured document (e.g., binary encoded document), and the like. Content 120, 152 can be an executable document, a non-executable document, user-generated content, automatically generated content, and the like. Content 120, 152, can include protected content (e.g., Digitally Rights Managed content), unprotected content, and the like. In one instance, content 120, 152 can be associated with an icon (e.g., desktop icon), a placeholder, and the like. That is content 120, 152 need not be visible to be shared. For example, a gesture 124 can be established to share a specific document within tablet 114 without requiring the document to be selected each time the gesture is invoked.

It should be appreciated that the disclosure can support gesture interaction with portions of the content 120, 152, visualizations of content 120, 152 (e.g., icons, graphs), and the like. In one instance, content 120, 152 can be treated as objects which can be manipulated via a set of universal operations (e.g., copy, print, move, rotate). It should be appreciated that content 120, 152 can be copied, moved, and/or mirrored.

As used herein, gesture 124 can be a physical movement associated with a user interface input. Gesture 124 can include, but is not limited to, a touch based gesture, a stylus based gesture, a keyboard based gesture, a pointing device gesture, and the like. Gesture 124 can include one or more characteristics including, but not limited to, direction, pressure, duration, and the like. For example, a gesture 124 can be detected as fast/slow or hard/soft. In one instance, characteristics of gesture 124 can affect content transmission options. For example, when a user performs a hard gesture (e.g., pressing firmly on a touch screen interface), content can be shared using priority based mechanisms (e.g., high transfer rates, fast transport protocols).

Gestures 124 include directional motions, such as a swipe, a flicking, a grabbing a portion of a screen and “throwing” it to another screen, etc. Screens that accept the “thrown” content, can either place the content on the receiving screen or can take actions based on receiving the content. In one embodiment, the gesture 124 can utilize accelerometers, gyroscopes, etc. to determine a hand motion made while holding a first screen. Thus, the gesture 124 need not be an on-screen gesture, but can be a physical gesture of direction/motion made while holding the first device or a controller linked to the first device. In one embodiment, “in the air” motions can be detected, such as using stereo cameras to detect motion, where these motions are able to be considered gestures 124 in context of the disclosure. In one embodiment, the gesture 124 can be to touch two proximate device to each other (physically touch). In still another embodiment, multiple different gestures 124 can be utilized, where different gestures indicate that different actions are to be taken. For example, touching two devices together may indicate a copy action is to be performed, while flicking a screen on one device to another (without touching the devices), may indicate that a selected file is to be moved from one device to the other.

As used herein, spatial interrelationship 130, 132 can be a spatial relation of device 116, 118 in reference to device 114. Interrelationship 130, 132 can include, but is not limited to, geospatial topology, directional relations, distance relations, and the like. For example, spatial interrelationship 130 can be defined using a cardinal coordinate system resulting in phone 116 positioned north easterly from tablet 114. In one instance, interrelationship 130, 132 can be data associated with a Global Positioning System coordinate, an inertial navigation system coordinate, and the like. It should be appreciated that the disclosure is not limited to utilizing spatial interrelationship 130, 132 to establish gesture based content transmission.

In scenario 110, a tablet 114 can be proximate to two devices, mobile phone 116 and computer 118 within a room 112. In the scenario 110, a user can utilize touch interactions such as a gesture 124 with a finger 111 to interact with content 120. In one instance, the disclosure can be utilized to determine the spatial interrelationship 130, 132 between proximate devices. In the instance, the interrelationship 130, 132 can be utilized to facilitate gestures which can trigger content sharing between the tablet 114 and devices 116, 118. For example, if a user selects content 120 and drags the content 120 in the direction of computer 118 (e.g., towards computer 118 position), the content can be automatically conveyed to computer 118 via BLUETOOTH.

In scenario 110, 140, 160, the direction of gesture 124 can be utilized to shared content with proximate devices 116, 118. For example, a gesture 124 can be performed with as a diagonal flick from a south westerly position to a north easterly position. It should be appreciated that the disclosure can measure direction utilizing an arbitrary coordinate system including, but not limited to, Euclidian coordinate system, cardinal coordinate system, and the like. It should be understood that the direction of the gesture can be utilized to share content with a proximate device in the approximate direction. For example, if mobile phone 116 is positioned north of tablet 114, the gesture 124 of a north easterly direction can trigger content 120 to be shared regardless of the inaccurate direction of the gesture. Conversely, the disclosure can support restrictions/limitations on the accuracy of gesture 124. In one embodiment, scenario 110, 140, 160 can including sharing content 120 via a directionless gesture. For example, if a user taps content 120 three times with finger 111, the content 120 can be shared with phone 116 and computer 118. That is, content 120 can be shared with all proximate devices 116, 118.

In one embodiment, user configurable settings can be used to define intended meaning (e.g., device targets) of direction based gestures. For example, a gesture 124 towards a boss's office may mean (intended user meaning) that content 120 is to be directed to a boss's device and/or email account. The computing device that receives the content 120 directed to the boss may not be located within the office, but may be carried by the boss or reside on a remotely located server. Thus, the “office” would represent a device proxy for the boss's computing device that is to receive the content 120. Similarly, a gesture 124 towards a person (who is a device proxy) may indicate (the gesture makers actual intent) that content is to be delivered to that person's computer or office.

In one embodiment, not all content 120 types will have the same intended delivery targets (receiving devices), which is behavior that the disclosure can handle. For example, email, files, video, and songs can be associated (via user configurable settings where these settings may be target device owner settings not the gesture maker established settings) with different delivery target devices.

In one embodiment, user (gesture maker) perspective and/or line of sight maybe significant in determining a gesture's intended meaning. For example, a gesture 124 toward the right will likely indicate conveyance of content 124 to a line of sight target. This is the case even though one or more device may exist to the right of the tablet 114, yet which are not within the user's line of sight (based on tablet 114 screen position). Semantic knowledge of content 120 and user behavior may increase a likelihood that gesture 124 interpretation matches a user's intent.

Ambiguity for a gesture's meaning may be resolved by prompting an end-user to resolve the ambiguity. For example, an onscreen (on tablet 114) prompt asking for clarification of whether content 120 is to be conveyed to device 116, 118, or both may be presented. In one embodiment, a learning algorithm may be utilized to detect patterns associated with historically made gestures 124. This learning algorithm may be used to improve accuracy of gesture 124 interpretation with use.

In one embodiment, the disclosure can support a content sharing whitelist, blacklist, and the like. For example, a whitelist can be established on tablet 114 permitting content 120 to be shared only with computer 118 regardless of the gesture 124 characteristics (e.g., direction, pressure). In one embodiment, security conditions and actions of arbitrary complexity can be implemented to ensure that content sharing is done in accordance with defined security policies/desires.

In scenario 140, an interface 142 can be presented in response to gesture 124. Interface 142 can be utilized to confirm content sharing to one or more appropriate devices. For example, interface 142 can be a confirmation dialog prompting a user to send content 120 to mobile phone 116. Upon confirmation, action 150 can be performed, sharing content 120 with phone 116. For example, action 150 can be a content copy action creating a copy of content 120 within device 116 as content 152. Interface 142 can be an optional interface, a mandatory interface, and the like. In one instance, interface 142 can support content 120 preview, content 140 management actions (e.g., rename, resize), and the like. In one instance, interface 140 can present a progress bar indicating the progress of action 150. In one embodiment, upon receipt of content 152, one or more executable operations can be optionally performed. For example, when content 152 is received appropriate application can be run to present content 152.

In one embodiment, the action 150 performed can preserve a state and/or of a process, object, application, as it exists in the first computing deivce 114, when conveyed to the second computing device 116. For example, a person watching a video in tablet 114 can perform a gesture 124 to “move” the video from tablet 114 to phone 116. The phone 116 can resume playing the video at a point where playback from the tablet 114 was terminated. In another embodiment, a flicking of a video can cause the video to continue playing on the tablet 114, but to also be displayed (concurrently, possibly with synchronized timing) and presented on device 116.

In scenario 160, a collaboration engine 170 can leverage spatial arrangement 172 and gesture mapping 174 to enable scenario 110, 140 to occur. Arrangement 172 can include position and/or orientation information of proximate devices 116, 118. For example, arrangement 172 can include interrelationship 130, 132 which can correspond to a location of phone 116 and computer 118 within room 112. It should be appreciated that the disclosure can support device moment. That is, devices 116, 118 can move about room 112 while enabling content 120 to be shared appropriately. For example, if phone 116 is moved prior to gesture 124 completion, a historic position of phone 116 at gesture 124 inception can be utilized to share content 120 appropriately. In one instance, the engine 170 can coordinate communication between devices utilizing an action list 180. For example, action list 180 can include a device a source device A, a target device B, an action to perform (e.g., copy), and a content (e.g., Image A) to convey. In one instance, action list 180 can enable multiple gestures to be performed consecutively. In the instance, action list 180 can be utilized to order and/or track content 120 sharing. For example, multiple different contents can be shared simultaneously utilizing list 180.

In one embodiment, content 120 recipient input may be utilized to increase security and/or to decrease receipt of misdirected and/or unwanted content 120. For example, responsive to the gesture 124 being made, one or more recipient devices (116, 118) may prompt their user to accept or refuse the content conveyance attempt. If accepted (via a user feedback) the content 120 is delivered. If active refused, or not accepted within a time out period of the gesture 124 being made, the content 120 is not delivered.

In one embodiment, the various devices 120, 116, 118 may belong to different individuals, causing the gesture 124 to share content 120. In another embodiment, the devices 120, 116, 118 may be a network of device used by a single end-user. These devices 120, 116, 118 may be designed for concurrent real-time use in one embodiment. For example, an end-user may simultaneously utilize a tablet 114 a home entertainment system (e.g., a television), and a computer. In such an example, the gestures 124 can convey the content 120 between the devices.

In various embodiments, the content 120 may be partially conveyed between different computer devices in response to the gesture 124. In other embodiments, the gesture 124 can cause proximate devices to react to the content 124, which the target devices may not receive. For example, the tablet screen 114 can show photos of various contestants of a competition show (concurrently displayed on a TV) and a flicking of one of the images towards the TV may indicate voting for that contestant. The TV in this example doesn't actually receive the “image” (or a file containing digitized content permitting a computer to render the image) that was “flicked” towards it. Instead, the tablet 114 from which the flicking occurred may convey a vote for the selected contestant to a remote server associated with the competition show being watched on the TV. Thus, the gesture 124 may represent a user intent that is less literal than the intent to convey the content 120 to a geospatially close device 116, 118, yet the flicking towards the device (e.g., TV) causes a set of programmatic actions to occur based on a user's programmatically determinable intent.

Drawings presented herein are for illustrative purposes only and should not be construed to limit the invention in any regard. It should be appreciated that the disclosure can be leveraged to easily convey content 120 to multiple proximate devices utilizing a single gesture. It should be appreciated that content 120 can be conveyed utilizing traditional and/or proprietary communication protocols, mechanisms, and the like. It should be appreciated that the disclosure can utilize traditional and/or proprietary mechanisms to share protected content and unprotected content. In one instance, protected content can be shared using traditional DRM sharing mechanisms (e.g., content purchasing prior to sharing). In another instance, unprotected content can be shared using a screen capture technique, a loopback recording technique, server based content delivery, and the like.

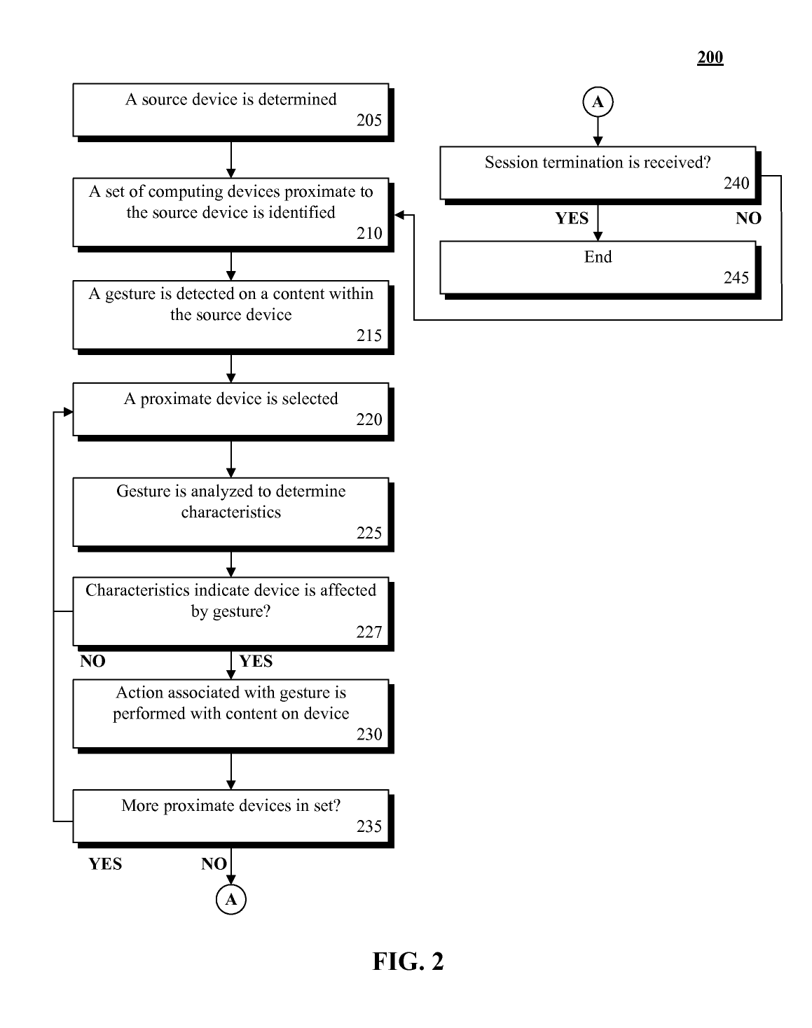

FIG. 2 is a schematic diagram illustrating a method 200 for enabling gesture driven content sharing between proximate computing devices in accordance with an embodiment of the inventive arrangements disclosed herein. Method 200 can be performed in the context of scenario 110, 140, 160 and/or system 300. In method 200, a gesture performed on a content within a source device can trigger the content transmission to one or more proximate devices. Method 200 can include one or more optional steps, including, but not limited to, device registration, presence information gathering, authentication, and the like.

In step 205, a source device can be determined. In one instance, the source device can be determined based on role, priority, proximity, and the like. For example, during a presentation, a device used by a presenter can be automatically identified as a source device. In step 210, a set of computing devices proximate to the source device can be identified. The proximate devices can be identified manually and/or automatically. In one instance, the proximate devices can be identified automatically based on presence information associated with each of the proximate devices. In the instance, presence information can include, but is not limited to, social networking presence information, text exchange (e.g., instant message) presence information, and the like. In step 215, a gesture can be detected on a content within the source device. The gesture can be detected at the application level, at the system level, and the like. For example, the gesture can be detected within a system event window manager or within a Web browser. In step 220, a proximate device can be selected. The proximate device can be selected in random order or in sequential order (e.g., alphabetical by device name). In step 225, gesture is analyzed to determine characteristics. Gesture analysis can include, but is not limited to, topological analysis, spatiotemporal analysis, and the like.

In step 227, if the characteristics indicate the device is affected by the gesture, the method can continue to step 230, else return to step 220. In step 230, an action associated with the gesture is performed with the content on the proximate device. In one embodiment, the action can be associated with traditional and/or proprietary communication actions. In the embodiment, content can be transmitted via electronic mail (e.g., attachment), text exchange messaging (e.g., Multimedia Messaging Service content), and the like. In one instance, action can be associated with a Wireless Application Environment (WAP) Push. The action can be associated with transport protocol security including, but not limited to, Secure Sockets Layer (SSL), Transport Layer Security (TLS), and the like.

The action can be associated with a device that detected the gesture and/or on the device targeted by the gesture. For example, the device that detected the gesture can be playing a video, which is dynamically conveyed (along with state information) to the device targeted by the gesture. In another example, an open document can be gestured towards a printer, which results in the original device printing the device to the selected printer (either using wireless or wire line conveyances). Context of a user interface from an originating device may be conveyed to the target device, and vice-versa. For example in one scenario, a user can gesture from an open tuner application on an originating device (from which no channel was selected) to a show playing on a proximate television, to change the channel in the open tuner application to that of the proximate television. This scenario requires the television to provide the tuner application with information of the current program, which the tuner application utilizes to adjust its playback (e.g., change the channel to the same channel as that of the television).

In step 235, if there are more proximate devices, the method can return to step 220, else continue to step 240. In step 240, if a session termination has been received, the method can continue to step 245, else return to step 210. In step 245, the method can end.

Drawings presented herein are for illustrative purposes only and should not be construed to limit the invention in any regard. The method 200 can be performed in the serial and/or in parallel. Steps 220-235 can be repeated continuously for each device proximate to the source device. Steps 210-240 can be performed for each gesture detected. The method 200 can be performed in real-time or near real-time.

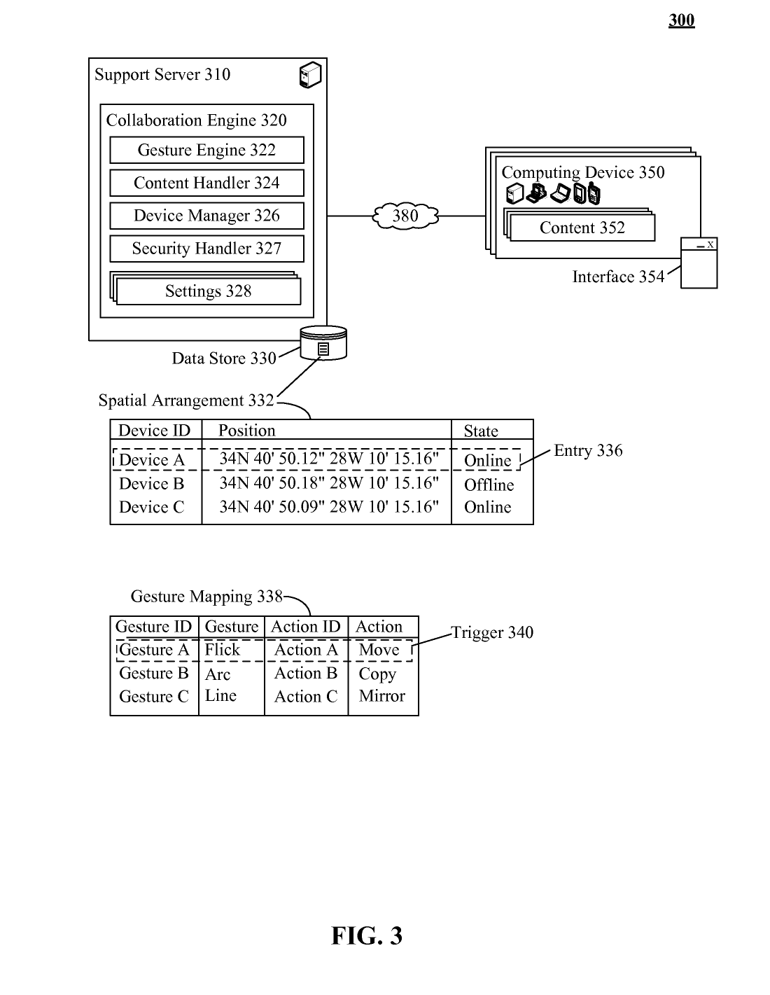

FIG. 3 is a schematic diagram illustrating a system 300 for enabling gesture driven content sharing between proximate computing devices in accordance with an embodiment of the inventive arrangements disclosed herein. System 300 can be performed in the context of scenario 110, 140, 160 and/or method 200. In system 300, a collaboration engine 320 can permit gesture based content sharing based on the spatial arrangement 332 of proximate computing devices. For example, a user can draw a circular arc across an icon of a document which can trigger the document to be shared with proximate devices within the angle of the arc. System 300 components can be communicatively linked via one or more networks 380.

Support server 310 can be a hardware/software element for executing collaboration engine 320. Server 310 functionality can include, but is not limited to, encryption, authentication, file serving, and the like. Server 310 can include, but is not limited to, collaboration engine 320, data store 330, an interface (not shown), and the like. In one instance, server 310 can be a computing device proximate to device 350. In another instance, server 310 can be a local computing device (e.g., gateway server), a local server (e.g., in-store computer), router, and the like.

Collaboration engine 320 can be a hardware/software component for permitting content sharing via gestures. Engine 320 can include, but is not limited to, gesture engine 322, content handler 324, device manager 326, security handler 327, settings 328, and the like. Engine 320 functionality can include, but is not limited to, session management, notification functionality, and the like. In one instance, engine 320 can be a client side functionality such as a plug-in for a Web browser permitting selective sharing of form-based content (e.g., text boxes, text field data). For example, a user can share data filled into a Web form with another users' device by performing a gesture (e.g., drawing a circle) on any portion of the Web form. In another embodiment, engine 320 can be a functionality of an Application Programming Interface (API).

Gesture engine 322 can be a hardware/software element for managing gestures associated with the disclosure. Engine 322 functionality can include, gesture detection, gesture editing (e.g., adding, modifying, deleting), gesture registration, gesture recognition, and the like. In one instance, engine 322 can permit the creation and/or usage of user customized gestures. For example, engine 322 can utilize gesture mapping 338 to enable user specific gestures. That is, each user can have a set of specialized gestures. In another instance, engine 322 can be utilized to present visualizations of registered gestures. In yet another instance, engine 322 can permit defining parameters (e.g., tolerances, mappings) associated with gestures, and the like. In the instance, engine 322 can allow gesture parameters including, but not limited to, distance tolerances, timing tolerances, transfer rates, and the like. It should be appreciated that gesture engine 322 can be utilized to support mouse chording gestures, multi-touch gestures, and the like.

Content handler 324 can be a hardware/software component for content 352 management associated with gesture based content 352 sharing. Handler 324 functionality can include, format identification, format conversion, content 352 selection, content 352 sharing, and the like. In one instance, handler 324 can permit a lasso selection of content 352 enabling free form content selection. In another instance, handler 324 can permit a marquee selection tool to allow region selection of content 352. It should be appreciated that content handler 324 can perform traditional and/or proprietary content transmission processes including, but not limited to, error control, synchronization, and the like. Content handler 324 can ensure state is conveyed along with content, in one embodiment.

Device manager 326 can be a hardware/software element for enabling device management within system 300. Manager 326 functionality can include, but is not limited to, device 350 tracking, presence information management, device 350 registration, protocol negotiation, and the like. In one instance, manager 326 can be utilized to manage spatial arrangement 332. In the instance, manager 332 can utilize arrangement 332 to determine device state, device position, device identity, and the like. For example, when a device is powered off, content 352 queued to be shared and can be shared when the device is powered on. In one instance, device manager 326 can forecast a device location when the current location is unknown. In the instance, device manager 326 can utilize historic presence information (e.g., position, velocity, orientation) to determine a likely position of the device. In another instance, device manager 326 can utilize near field communication technologies (e.g., BLUETOOTH) to obtain presence information from a device.

In one instance, when a device cannot be automatically located, a user can be prompted to manually identify the device via a scene, a map and/or a selection interface. In instances where GPS location alone is not sufficient to identify the sending and receiving devices, (e.g., when there are more than two connected parties), device accelerometer and/or compass information can be utilized to obtain location information. In one embodiment, compass, accelerometer, and/or GPS information can be used to triangulate a target device in relation to the flick gesture that can initiate the content communication.

Security handler 327 can define security constraints/conditions for sending and/or receiving content to/from other devices as a result of gestures. In one embodiment, the security handler 327 can establish a set of different trust levels. Proximate devices with a greater trust level can be granted preferential treatment (regarding content sharing) over proximate devices with a lesser trust level. Individual content items can also have associated security constraints. In one embodiment, the security handler 327 may require a receiving (or sending) device to possess a security key, which acts as an authorization to send/receive otherwise restricted information. In one embodiment, the security handler 327 may encrypt/decrypt information conveyed between devices to ensure the information is properly secured. The security handler 327 in one embodiment, may implement password protections, which require suitable passwords before information is conveyed/received/decrypted.

In one embodiment, the security handler 327 can utilize one or more biometric. For example, a fingerprint of a user performing a touch on a touch screen can determined and utilized as authorization. Similarly, hand size, finger size, and the like can be used. Likewise, behavioral biometrics, such as swiping characteristics, typing patterns, and the like can be used for security purposes. In one embodiment, an authorizing step may need to be performed at a source device, a destination device, or both in order for a gesture triggered action to be completed. For example, a user holding two device can gesture from the source device to the target device to perform a copy action. This device may read the user's fingerprints on each screen, and only perform the action if the fingerprints match. Similarly, two different users (one per device) may have their fingerprints read, and the security handler 327 can authorize/refuse a desired action depending on the identifies of the users and permissions established between them.

In one embodiment, the security handler 327 can further ensure digital rights management (DRM) and other functions are properly handled. For example, a user may only be authorized to concurrently utilize a limited quantity of a copyright protected (or license protected) work, the utilizations of this work can be tracked and managed by the security handler 327 to ensure legal rights are not exceeded.

Settings 328 can be one or more options for configuring the behavior of system 300, server 310, and/or collaboration engine 320. Settings 328 can include, but is not limited to, gesture engine 322 options, content handler 324 settings, device manager 326 options, and the like. Settings 328 can be presented within interface 352, a server 310 interface, and the like. In one embodiment, settings 328 can be utilized to establish customized transfer rates for content type, content size, device type, device proximity, and the like.

Data store 330 can be a hardware/software component able to persist spatial arrangement 332, gesture mapping 338, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Spatial arrangement 332 can be a data set configured to facilitate gesture based content sharing. Arrangement 332 can include, but is not limited to, device identifier, device position, device state, active user, and the like. For example, entry 336 can permit tracking an online device A at a GPS position of 34N 40′ 50.12″ 28W 10′15.16″. In one instance, arrangement 322 can be dynamically updated in real-time. Arrangement 332 can utilize relative positions, absolute positions, and the like. In one instance, arrangement 332 can track spatial interrelationships between proximate devices.

Gesture mapping 338 can be a data set able to map a gesture to a content action which can facilitate gesture based content sharing. Mapping 338 can include, but is not limited to, a gesture identifier, a gesture descriptor, an action identifier, an action, and the like. In one instance, mapping 338 can be dynamically updated in real-time. In one instance, mapping 338 can be presented within interface 354 and/or a server 310 interface (not shown). In one embodiment, mapping 338 can be utilized to establish triggers which can link a gesture to an executable action. For example, trigger 340 can permit a flick to perform a move content action.

Computing device 350 can be a hardware/software permitting the handling of a gesture and/or the presentation of content 352. Device 350 can include, but is not limited to, content 352, interface 354, and the like. Computing device 350 can include, but is not limited to, a desktop computer, a laptop computer, a tablet computing device, a PDA, a mobile phone, and the like. Computing device 350 can be communicatively linked with interface 354. In one instance, interface 354 can present settings 328, arrangement 332, mapping 338, and the like.

Content 352 can be one or more digitally encoded data able to presented within device 350. Content 352 can include one or more traditional and/or proprietary data formats. Content 352 can be associated with encryption, compression, and the like. Content 352 can include Web-based content, content management system (CMS) content, source code, and the like. Content 352 can include, but is not limited to, a Extensible Markup Language (XML) document, Hypertext Markup Language (HTML) document, a flat text document, and the like. Content 352 can be associated with metadata including, but not limited to, security settings, permission settings, expiration data, and the like. In one instance, content 352 can be associated with an expiration setting which can trigger the deletion of shared content upon reaching an expiration value. For example, a user can permit content 352 to be shared for five minutes before the content is no longer accessible.

Interface 354 can be a user interactive component permitting interaction and/or presentation of content 352. Interface 354 can be present within the context of a desktop shell, a desktop application, a mobile application, a Web browser application, an integrated development environment (IDE), and the like. Interface 354 capabilities can include a graphical user interface (GUI), voice user interface (VUI), mixed-mode interface, and the like. In one instance, interface 354 can be communicatively linked to computing device 350.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), VPN and the like.

It should be appreciated that engine 320 can leverage supporting systems such as devices which permit three dimensional gesture recognition (e.g., game console motion detector). In one embodiment, engine 320 can permit a three dimensional scene to be created to present device spatial interrelationship. In one instance, the scene can be created via the network connection between the devices, device sensors such as WiFi triangulation, GPS positioning, Bluetooth communication, near field communication, gyroscope, and/or digital compasses.

Drawings presented herein are for illustrative purposes only and should not be construed to limit the invention in any regard. In one embodiment, engine 320 can be a component of a Service Oriented Architecture (SOA). Protocols associated with the disclosure can include, but is not limited to, Transport Control Protocol (TCP), Internet Protocol (IP), Real-time Transport Protocol (RTP), Session Initiated Protocol (SIP), Hypertext Transport Protocol (HTTP), and the like. It should be appreciated that engine 320 can support sending/receiving of partial content. In one embodiment, engine 320 can permit touch based content sharing. For example, a user can touch a source device and associated content and then touch the destination device with destination location.

In one instance, selected portions of a static image and/or a video can be transmitted to a proximate device. For example, a user can select cue points of sections of a media file into sub-sections and then “flick” or “throw” the selection to another user's device. In one embodiment, the disclosure can support group based content sharing, user based content sharing, and the like. For example, a gesture can be mapped to share content with a proximate devices belonging to a specific group.

It should be appreciated that the disclosure can permit sending and/or receiving of content based on detected gestures. Further, the disclosure can permit distinguishing of interaction type, touch based gesture, device touch gestures (e.g., touching two or more devices), device motion gestures (e.g., shake), and the like.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for permitting communication between devices comprising:
identifying one or more computing devices proximate to a source device, wherein the source device is an end-user device having a touch sensitive surface;
detecting a gesture performed on the touch sensitive surface, wherein the gesture indicates a selection of a displayed representation of content and indicates a direction, wherein the gesture is at least one of a touch based gesture, a stylus based gesture, a keyboard based gesture, and a pointing device gesture;
determining a target device or a device proxy that is within line-of-site of a human being that made the gesture and that is in the direction of the gesture; and
programmatically executing an action involving the gesture selected content and the determined target device or device proxy.

2. The method of claim 1, wherein the direction of movement is based on detected movement of a contact object continuously in contact with the touch sensitive surface for the duration of the movement.

3. The method of claim 1, wherein the human being concurrently utilizes the source device and the one or more computing devices, wherein the action is a real-time action contextually dependent upon real-time information presented on the one or more computing devices at a time the gesture was detected.

4. The method of claim 1, wherein the selection is a graphical representation of the content presented on a screen of the source device, wherein the action conveys a file or a message containing at least a portion of the content to a memory of the identified one or more computing devices.

5. The method of claim 1, determining a spatial interrelationship between the source device and the plurality of computing devices.

6. The method of claim 5, wherein the determining establishes at least one of a position, orientation, and velocity of each of the plurality of computing devices with the source device as a frame of reference.

7. The method of claim 1, wherein the action is dependent on a speed, a pressure, or a combination of speed and pressure of the gesture.

8. The method of claim 1, further comprising:
approximately matching a velocity vector characteristic of the gesture with a spatial interrelationship of the one or more computing devices.

9. The method of claim 1, wherein the action is at least one of a content copy, a content move, and a content minor.

10. The method of claim 1, wherein the content is a portion of at least one of a video, an image, an audio, and a document.

11. The method of claim 1, further comprising:
prior to the executing, detecting user fingerprints input on a source computing device and on a destination computing device, wherein the action is only processed when the detected fingerprints match or when users associated with each of the fingerprints have authorized each other for the action on the source and the destination computing device.

12. The method of claim 1, wherein the action is establishing a communication between the source device and at least one of the plurality of computing devices.

13. The method of claim 1, wherein the gesture performed is a flick gesture.

14. A system for sharing content between proximate computing devices comprising:
a collaboration engine configured to share content associated with a first computing device and with a second computing device responsive to a gesture performed on the first computing device, wherein a characteristic of the gesture determines an action performed on the second computing device, wherein the gesture is at least one of a touch based gesture, a stylus based gesture, a keyboard based gesture, and a pointing device gesture, wherein the second computing device is proximate to the first computing device; and
a data store configured to persist at least one of a gesture mapping, an action list, and a spatial arrangement.

15. The system of claim 14, wherein the content is at least a portion of a video content, an audio content, an image content and a document content.

16. The system of claim 14, wherein the gesture is at least one of a copy content gesture and a move content gesture, wherein action run upon the second computing device is at least one of a corresponding copy content action and a move content action.

17. The system of claim 14, further comprising:
a gesture engine configured to detect a characteristic of a gesture performed within the first computing device;
a content handler able to select at least a portion of the content associated with the gesture; and
a device manager configured to determine an spatial interrelationship between the first computing device and the second computing device, wherein the spatial interrelationship is at least one of a vector.

18. The system of claim 17, wherein the device manager is configured to determine a spatial interrelationship of the second computing device, wherein the determining is performed by at least one of a Global Positioning System, a camera, an inertial navigation system, a compass, and an accelerometer.

19. The system of claim 14, wherein the data store is able to persist the content within a server environment.

20. The system of claim 19, wherein the second computing device is configured to access the content within the data store.

21. A computer program product comprising a computer readable storage medium having computer usable program code embodied therewith, the computer usable program code comprising:
computer usable program code stored in a storage medium, if said computer usable program code is processed by a processor it is operable to identify one or more computing devices proximate to a source device, wherein the source device is an end-user device having a touch sensitive surface;
computer usable program code stored in a storage medium, if said computer usable program code is processed by a processor it is operable to detect a gesture performed on the touch sensitive surface, wherein the gesture indicates a selection of a displayed representation of content and indicates a direction, wherein the gesture is at least one of a touch based gesture, a stylus based gesture, a keyboard based gesture, and a pointing device gesture;
computer usable program code stored in a storage medium, if said computer usable program code is processed by a processor it is operable to determine a target device or a device proxy that is within line-of-site of a human being that made the gesture and that is in the direction of the gesture; and
computer usable program code stored in a storage medium, if said computer usable program code is processed by a processor it is operable to programmatically execute an action involving the gesture selected content and the determined target device or device proxy.

22. The computer program product of claim 21, wherein the human being concurrently utilizes the source device and the one or more computing devices, wherein the action is a real-time action contextually dependent upon real-time information presented on the one or more computing devices at a time the gesture was detected.

23. The computer program product of claim 21, wherein the selection is a graphical representation of the content presented on a screen of the source device, wherein the action conveys a file or a message containing at least a portion of the content to a memory of the identified one or more computing devices.

24. A method comprising:
establishing a system of communicatively linked devices in a spatial region for concurrent use by a human in the spatial region, each of the linked devices having a screen for display to the human, wherein screens used by different ones of the linked devices render content provided from independent content presentation functions;
detecting a gesture performed by the human on a touch sensitive surface of a first one of the communicatively linked device, wherein the gesture indicates a selection of a displayed representation of content and indicates a direction through movement of a contact object on the touch sensitive surface; and
responsive to the gesture, conveying over a communication linkage at least a portion of the content to a second one of the communicatively linked devices, wherein the conveyed portion of the content is stored in a memory of the second one of the communicatively linked devices.

25. The method of claim 24, further comprising:
the second device performing a programmatic action contextually dependent upon the at least a portion of the content conveyed in response to the gesture.
